(19) United States
(12) Patent Application Publication
(10) Pub. No.: US 2018/0305250 A1
(43) Pub. Date: Oct. 25, 2018

(54) METHOD FOR RAPID ANNEALING OF A STACK OF THIN LAYERS CONTAINING AN INDIUM OVERLAY

(71) Applicant: SAINT-GOBAIN GLASS FRANCE, Courbevoie (FR)

(72) Inventors: Antoine DIGUET, Paris (FR); Nicolas MERCADIER, Paris (FR); Johann SKOLSKI, Paris (FR); Matthieu ORVEN, Gennevilliers (FR); Camille JOSEPH, Nantes (FR); Yemima BON SAINT CÔME, Paris (FR)

(21) Appl. No.: 15/768,411

(22) PCT Filed: Oct. 12, 2016
(86) PCT No.: PCT/FR2016/052636

§ 371 Date: Apr. 13, 2018

(30) Foreign Application Priority Data
Oct. 16, 2015 (FR) 1559882

(51) Int. Cl. C03C 17/36; B32B 17/10

(52) U.S. Cl. CPC C03C 17/3618; C03C 17/3644; C03C 17/366; C03C 2218/322; B32B 17/10018; C03C 17/3681; C03C 2217/948; C03C 17/3689

(57) ABSTRACT

A heat treatment process includes irradiating a substrate including a glass sheet coated on one of its faces with a stack of thin layers, under an atmosphere containing oxygen (O₂), with electromagnetic radiation having a wavelength comprised between 500 and 2000 nm, the electromagnetic radiation being emitted by an emitter device placed facing the stack of thin layers, a relative movement being created between the emitter device and the substrate, so as to raise the stack of thin layers to a temperature at least equal to 300° C. for a brief duration shorter than one second, wherein the last layer of the stack, making contact with the atmosphere, called the overcoat, is a metal layer of indium or of an indium-based alloy.

The invention relates to the field of inorganic thin layers, deposited on substrates made of glass or made of plastic. It in particular relates to a rapid annealing process for superficially annealing stacks of thin layers after deposition using an electromagnetic radiation absorbing overcoat.

Many thin mineral layers are deposited on transparent substrates, in particular substrates made of flat or slightly curved glass, in order to provide the obtained items with particular properties: optical properties, for example of reflection or absorption of radiation in a given wavelength domain, particular electrical conduction properties, or even properties related to the ease of cleaning or to the ability of the material to self-clean.

One process commonly employed on the industrial scale for the deposition of thin layers, in particular on glazing substrates, is the magnetic field assisted cathodic sputtering process called the “magnetron” process. In this process, a plasma is created under a high vacuum in the vicinity of a target comprising the chemical elements to be deposited. The active species of the plasma, on bombarding the target, tear out said elements, which deposit on the substrate thereby forming the desired thin layer. This process is said to be “reactive” when the layer is formed from a material resulting from a chemical reaction between the elements torn from the target and the gas contained in the plasma. The major advantage of this process resides in the ability to deposit on a given line a very complex stack of layers by making the substrate run in succession under various targets.

During the industrial implementation of the magnetron process, the substrate remains at room temperature or experiences a moderate increase in temperature (less than 80° C.), particularly when the run speed of the substrate is high, this generally being desirable for economic reasons. This moderate temperature, which may at first sight appear to be an advantage, is however a drawback in the case of the aforementioned layers, because the low deposition temperatures generally do not allow a sufficiently low resistivity to be obtained. Heat treatments are then necessary to obtain the desired resistivity.

It is known to carry out a rapid local laser anneal (laser flash heating) of thin coatings deposited on flat substrates. To do this, the substrate is made to run with the coating to be annealed under a laser line, or indeed a laser line is run over the substrate bearing the coating (see for example WO2008/096089 and WO2013/156721).

The laser anneal allows thin coatings to be heated for a fraction of a second to high temperatures, of about a few hundred degrees, while preserving the subjacent substrate.

It has also been proposed to replace in such a superficial rapid annealing process the laser light sources, such as laser diodes, with intense pulsed light (IPL) lamps, which are also called flash lamps. In the international patent application WO2013/026817 a process for manufacturing a low-emissivity coating is thus proposed comprising a step of depositing a thin silver-based layer, then a step of superficial rapid annealing of said layer with the aim of decreasing its emissivity and increasing its conductivity. In the annealing step, the substrate coated with the silver layer is made to run under a set of flash lamps downstream of the deposition station of the layer.

In order for the rapid anneal to be effective, the thin layer or stack to be annealed must absorb at least some of the electromagnetic radiation used. To mitigate an insufficient absorption, it has been proposed to deposit on the stack to be annealed a thin “provisional” layer absorbing strongly the radiation used. The thin absorbing layer may be removed after treatment, for example by washing, or indeed it may be chosen so as to become sufficiently transparent after the heat treatment.

Thus, it is known, in particular from WO2010/142926, to use an overcoat made of Ti metal that effectively absorbs infrared radiation and which oxidizes, in contact with the atmosphere and under the influence of the heat, into TiO₂. However, titanium dioxide has a number of drawbacks: its refractive index is particularly high (about 2.6 at a wavelength of 550 nm) and the presence of a thin TiO₂ layer as last layer of a low-E stack of an insulating glazing may decrease or, conversely, increase undesirably the solar gain g of the glazing. Moreover, the presence of a layer of TiO₂ on the transparent conductive oxides (TCOs), such as ITO (indium tin oxide), serving as electrodes for photovoltaic cells or electro-optic devices, may decrease the quality of the electrical contacts and complicate the patterning of the TCO by laser abrasion or chemical etching.

Another absorbing overcoat, already used by the Applicant, is a thin layer made of SnZn alloy that strongly absorbs infrared radiation and oxidizes in contact with the atmosphere and under the influence of the increase in the temperature into SnZnO. The thickness of overcoats of SnZn is however limited to only a few nanometers. For larger thicknesses, a sufficient oxidation of the alloy either requires durations of exposure to the radiation that are too long—i.e. run speeds that are too low, or extremely high laser powers. In both cases, this results in an undesirable increase in the production costs associated with the annealing step.

The present invention is based on the discovery that indium metal or an indium-based alloy may be used very effectively by way of temporary overcoat to rapidly anneal stacks of thin layers. This metal, although more expensive than titanium or the alloy SnZn, has the advantage of oxidizing more easily than them. This ease of oxidation allows a superficial anneal to be implemented at much higher run speeds than for known overcoats based on titanium or SnZn.

In addition, when indium is used in the form of an alloy with tin, the oxidation results in ITO, the most widespread transparent conductive oxide. Thus, an overcoat made of indium-tin alloy (InSn) deposited on an ITO layer will meld, after oxidation, with the subjacent ITO layer. The well-suitedness to structuring by chemical etching or laser is not decreased.

Moreover, the refractive index of indium oxide (comprised between 1.4-1.5) and that of ITO (about 1.8) are lower than that of TiO₂. When overcoats based on indium metal are used to improve the absorbance of a low-E stack for insulating glazings, the presence of a final layer made of In₂O₃ or of an oxide of an indium alloy, such as ITO, will have fewer negative repercussions on the solar gain than a final layer of TiO₂.

One subject of the present invention is a heat treatment process comprising irradiating a substrate comprising a transparent sheet, preferably a glass sheet, coated on one of its faces with a stack of thin layers, under an atmosphere containing oxygen (O₂), with electromagnetic radiation having a wavelength comprised between 500 and 2000 nm, said electromagnetic radiation being emitted by an emitter device placed facing the stack of thin layers, a relative movement being created between said emitter device and said substrate, so as to raise the stack of thin layers to a temperature at least equal to 300° C. for a brief duration shorter than one second and preferably shorter than 0.1 seconds, said process being characterized in that the last layer of the stack, making contact with the atmosphere, called the overcoat, is a layer of indium or of an indium-based alloy.

Another subject of the present application is a substrate for the implementation of such a process. This substrate comprises a transparent sheet, preferably a glass sheet, coated on one of its faces with a stack of thin layers, the last layer of which, making contact with the atmosphere, called the overcoat, is a layer of indium or of an indium-based alloy, and preferably of an indium-tin alloy (InSn).

Lastly, another subject of the present application is a substrate obtainable with a process such as defined above and defined in more detail below.

The expression “indium-based alloy” is understood, in the present application, to mean an alloy containing a majority of indium atoms, i.e. more than 50% indium atoms relative to the total amount of metal atoms in the alloy.

An alloy of indium containing more than 60%, in particular more than 70% and even more preferably more than 80% indium atoms relative to the total amount of metal atoms in the alloy will preferably be used.

The overcoat of indium or of indium-based alloy is a metal layer. This term encompasses, in the present application, layers in which all the atoms are in the 0 oxidation state but also slightly oxidized layers. Specifically, it is very difficult, or even impossible to deposit a deposit by cathode sputtering in the total absence of oxygen, which is always present in trace amounts. Moreover, the metal overcoat, when it is left in the open air after the deposition for several hours, or even several days, gradually changes appearance, probably following a surface oxidation. Lastly, the Applicant has observed that the presence of small quantities of oxygen (up to about 5 mol %) introduced into the plasma during the deposition in no way adversely affects the effectiveness of the overcoat.

The term “metal overcoat” therefore encompasses in the present application overcoats containing up to 10% oxygen atoms relative to the total amount of metal and oxygen atoms.

It is impossible to indicate the actual thickness of the indium metal or indium alloy overcoat. Specifically, indium and some indium alloys have a quite low melting point and an effect of dewetting of thin solid films, widely described in the literature in particular for thin films of gold or silver, probably occurs. The overcoat of indium or indium-based alloy is therefore not a continuous layer of uniform thickness but consists of elements of rounded shape, having submicron-sized dimensions. Analysis by atomic force microscopy (AFM) carried out on the overcoats, before and after heat treatment, has revealed that these relief elements have a “sugarloaf” shape (peaks of substantially parabolic shape). The Applicant has observed that this characteristic shape of the surface elements of the overcoat is preserved after heat treatment and it therefore constitutes a marker of the substrate before heat treatment but also of the substrate obtained by the process according to invention. The diameter of these relief elements, seen from above, is about a few tens of nanometers, and generally comprised between 10 and 200 nm.

The parameter allowing the quantity of deposited material to be most clearly and most directly characterized seems to be the mass per unit area of the overcoat. In order for this mass per unit area to be independent of the degree of oxidation, it will be expressed as the mass of all of the metal atoms (indium and alloyed metals) per unit area. This mass per unit area in principle does not vary significantly during the rapid annealing process and in principle is found unaltered in the final product after annealing.

This mass per unit area may be determined by electron microprobe or Castaing microprobe microanalysis, for example an “SX Five” model microprobe from the company Cameca (15 kV, line mode, at 150 nA, on the elements and lines: In-Lα and Sn-Lα). If necessary, this electron microprobe microanalysis may be combined with an analysis by secondary ion mass spectrometry (SIMS).

This mass per unit area may then be used to calculate what could be called an “equivalent thickness of the metal overcoat”, by dividing it by the density of the material. A pure indium layer of a mass per unit area of 10 μg/cm² having a theoretical density of 7.31 g/cm³ would thus have an equivalent thickness of 13.7 nm. However, this equivalent thickness does not take into account the increase in the actual thickness of the overcoat due to possible oxidation, which may be partial or complete.

The mass per unit area of the overcoat, expressed as the mass of metal atoms per unit area, is advantageously comprised between 1 and 30 μg/cm², preferably between 3 and 25 μg/cm² and in particular between 4 and 15 μg/m².

The heat treatment according to the invention results in an oxidation of the surface layer and therefore modifies the fraction of metal atoms in the overcoat. It is however important to note that the heat treatment does not modify the amount of metal atoms per unit area of the overcoat and the mass per unit area ranges indicated above are therefore valid for the overcoat before and after heat treatment according to the invention.

The indium may be alloyed with one or more other metals. The metal or metals and their atomic proportion in the alloy must be chosen so that, after complete oxidation, the absorption of the overcoat is negligible relative to the absorption of the initial alloy in the metal state.

Mention may be made by way of nonlimiting examples of such alloy metals of Al, Ga, Ge, Zn, Ti, Sn, Bi, Pb, Ad, Ag, Cu and Ni.

Tin (Sn) in a proportion comprised between 5 and at % and in particular between 8 and 20 at % will particularly preferably be used. In one particularly preferred embodiment, illustrated below in the examples, the overcoat is a layer of an indium-tin alloy (InSn), in particular an alloy containing about 90% indium atoms and 10% tin atoms.

The process according to the invention is particularly advantageous for the manufacture of glass sheets intended for the manufacture of insulating glazings. These glass sheets bear on their surface a stack of thin layers, called a low-emissivity or low-E stack, comprising at least one metal layer that reflects infrared radiation, preferably a silver layer, between two dielectric layers.

Such low-emissivity stacks are known in the art. They may include a single silver layer or a plurality of silver layers, for example two or three silver layers.

Glass sheets with stacks including a single silver layer are sold by the Applicant, for example under the trade name Planitherm® One.

Generally, the stack of thin layers subjected to a rapid anneal according to the invention preferably comprises at least one electrically conductive layer other than the overcoat making contact with the atmosphere. This electrically conductive layer may be a metal layer, for example a silver layer as mentioned above, or indeed a layer of a transparent conductive oxide.

In one embodiment of the process of the present invention, the penultimate layer of the stack of thin layers, i.e. the layer located directly under the indium-based overcoat making contact with the atmosphere, is a layer of indium tin oxide (ITO). This embodiment is particularly advantageous when the overcoat is made of InSn alloy because the thickness of the ITO layer formed by oxidation of the overcoat adds to that of the subjacent ITO layer and therefore decreases the sheet resistance (P) thereof.

In another embodiment, the stack of thin layers comprises a metal functional layer, in particular one based on silver, placed between two antireflection coatings each including at least one dielectric layer. The antireflection coating located between the indium-based overcoat and the functional layer preferably comprises a layer of silicon nitride, of a thickness comprised between about 10 and 50 nm, making direct contact with the overcoat, and a layer of a metal oxide having a refractive index comprised between 2.3 and 2.7 and preferably having a thickness comprised between 5 and 15 nm, making direct contact with the layer of silicon nitride.

The process according to the invention is preferably implemented under conditions such that the step of rapid thermal annealing by irradiation leads to a decrease in the sheet resistance and/or the emissivity of the stack of thin layers of at least 15% and preferably of at least 20%. This decrease of course includes that which results from the contribution of the oxidized overcoat to the conductivity of the complete stack.

According to one preferred embodiment, the electromagnetic radiation is laser radiation, in other words the emitter device is a laser, preferably a laser emitting a laser beam focused on the plane of the overcoat, in the form of a laser line simultaneously irradiating all or some of the width of the substrate and preferably all the width of the substrate.

The laser radiation is preferably generated by modules comprising one or more laser sources and shaping and redirecting optics.

The laser sources are typically laser diodes or fiber-delivered lasers, in particular fiber lasers, diode-pumped lasers or even disk lasers. The laser diodes allow high power densities to be obtained economically with respect to the electrical supply power, for a low bulk. The bulk of fiber-delivered lasers is even smaller, and the power per unit length obtained may be even higher, at a higher cost however. The expression “fiber-delivered lasers” is understood to mean lasers in which the place of generation of the laser light is spatially remote with respect to its place of delivery, the laser light being delivered by means of at least one optical fiber. In the case of a disk laser, the laser light is generated in a resonant cavity in which the emitting medium, which takes the form of a disk, for example a thin disk (of about 0.1 mm thickness) made of Yb:YAG is found. The light thus generated is coupled to at least one optical fiber that is directed toward the place of treatment. Fiber or disk lasers are preferably pumped optically using laser diodes.

The radiation emitted by the laser sources is preferably continuous wave.

The wavelength of the laser radiation is preferably comprised in a range extending from 900 to 1100 nm and in particular from 950 to 1050 nm.

In the case of a disk laser, the wavelength is for example 1030 nm (emission wavelength for a Yb:YAG laser). For a fiber laser, the wavelength is typically 1070 nm.

In the case of lasers that are not fiber-delivered, the shaping and redirecting optics preferably comprise lenses and mirrors, and are used as means for positioning, focusing and increasing the uniformity of the beam.

The aim of the positioning means is to arrange the radiation emitted by the laser sources in a line. They preferably comprise mirrors.

The aim of the means for increasing uniformity is to superpose the spatial profiles of the laser sources in order to obtain a power per unit length that is uniform all the way along the line. The means for increasing uniformity preferably comprise lenses allowing the incident beams to be separated into secondary beams and said secondary beams to be recombined into a uniform line.

The means for focusing the radiation allow the radiation to be focused on the stack of thin layers to be treated, and more particularly on the absorbing overcoat, in the form of a line of the desired length and width. The focusing means preferably comprise a focusing mirror or a convergent lens.

In the case of fiber-delivered lasers, the shaping optics are preferably grouped together in the form of an optical head positioned at the exit of the optical fiber or of each optical fiber.

The shaping optics of said optical heads preferably comprise lenses, mirrors and prisms and are used as means for converting, focusing and increasing the uniformity of the radiation.

The converting means comprise mirrors and/or prisms and serve to convert the circular beam, output from the optical fiber, into an anisotropic noncircular line-shaped beam. To do this, the converting means increase the quality of the beam along one of its axes (fast axis, or axis of the width w of the laser line) and decrease the quality of the beam along the other (slow axis, or axis of the length L of the laser line).

The means for increasing uniformity superpose the spatial profiles of the laser sources in order to obtain a power per unit length that is uniform all the way along the line. The means for increasing uniformity preferably comprise lenses allowing the incident beams to be separated into secondary beams and said secondary beams to be recombined into a uniform line.

Lastly, the means for focusing the radiation allow the radiation to be focused on the working plane, i.e. in the plane of the thin layer stack to be treated, in the form of a line of the desired length and width. The focusing means preferably comprise a focusing mirror or a convergent lens.

When a single laser line is used, the length of the line is advantageously equal to the width of the substrate. This length is typically at least 1 m, in particular at least 2 m and in particular at least 3 m. A plurality of optionally separate lines may also be used, but arranged so as to treat the entire width of the substrate. In this case, the length of each laser line is preferably at least 10 cm, preferably at least cm, in particular comprised in a range extending from 30 to 100 cm, preferably from 30 to 75 cm and in particular from 30 to 60 cm.

By the “length” of the line, what is meant is the largest dimension of the line, as measured on the surface of the stack of thin layers, and by “width” the dimension in a second direction perpendicular to the first. As is conventional in the field of lasers, the width (w) of the line corresponds to the distance, in this second direction, between the axis of the beam on which the intensity of the radiation is maximal and the point where the intensity of the radiation is equal to 1/e² times the maximum intensity.

The average width of a laser line is preferably at least 35 μm, in particular comprised in a range extending from 40 to 100 μm and in particular from 40 to 70 μm. Throughout the present text, the term “average” is understood to mean the arithmetic mean. Over the entire length of the line, the width distribution is narrow in order to limit as much as possible any nonuniformity in treatment. Thus, the difference between the largest width and the smallest width is preferably at most 10% of the value of the average width. This value is preferably at most 5%.

The shaping and redirecting optics, in particular the positioning means, may be adjusted manually or using actuators allowing their distancewise position to be adjusted. These actuators (typically motors or piezoelectric actuators) may be controlled manually and/or adjusted automatically. In the latter case, the actuators will preferably be connected to detectors and to a feedback loop.

At least some of the laser modules and even all of them are preferably placed in a sealed enclosure that is advantageously cooled, in particular fan-cooled, in order to ensure their thermal stability.

The laser modules are preferably mounted on a rigid structure, called a “bridge”, based on metal elements that are typically made of aluminum. The structure preferably does not comprise a marble sheet. The bridge is preferably positioned parallel to the conveying means so that the focal plane of the laser line remains parallel to the surface of the substrate to be treated. Preferably, the bridge comprises at least four feet, the height of which may be individually adjusted in order to ensure, whatever the case may be, that the bridge and conveying means are parallel to each other. The adjustment may be achieved by way of motors located in each foot, either manually, or automatically in relation with a distance sensor. The height of the bridge may be modified (manually or automatically) to take into account the thickness of the substrate to be treated, and thus ensure that the plane of the substrate coincides with the focal plane of the laser line.

The power per unit length of the laser line is advantageously at least 300 W/cm, preferably at least 400 W/cm and in particular at least 500 W/cm. It is even advantageously at least 600 W/cm, in particular 800 W/cm and even 1000 W/cm. The power per unit length is measured in the focal plane of the laser line, i.e. in the plane of the thin-layer stack, also called the working plane of the equipment.

It may be measured by placing a power detector along the line, for example a calorimetric power meter, in particular such as the Beam Finder (S/N 2000716) power meter sold by Coherent Inc. The power is advantageously distributed uniformly over the entire length of the laser line. Preferably, the difference between the highest power and the lowest power is less than 10% of the average power.

The energy density delivered to the stack of thin layers by the laser device is preferably comprised between 20 J/cm² and 500 J/cm² and in particular between 50 J/cm² and 400 J/cm².

According to another preferred embodiment, the device that emits the electromagnetic radiation is an intense pulsed light (IPL) lamp, called a flash lamp below.

Such flash lamps generally take the form of glass or quartz tubes that are sealed and filled with a noble gas and that are equipped with electrodes at their ends. Under the effect of an electrical pulse of short duration, obtained by discharging a capacitor, the gas ionizes and produces a particularly intense burst of incoherent light. The emission spectrum generally includes at least two emission lines; it is preferably a continuous spectrum having an emission maximum in the near ultraviolet.

The lamp is preferably a xenon lamp. It may also be an argon lamp, a helium lamp or a krypton lamp. The emission spectrum preferably comprises a plurality of lines, in particular at wavelengths ranging from 160 to 1000 nm.

The duration of each light pulse is preferably comprised in a range extending from 0.05 to 20 milliseconds and in particular from 0.1 to 5 milliseconds. The repetition rate is preferably comprised in a range extending from 0.1 to 5 Hz and in particular from 0.2 to 2 Hz.

The radiation may be emitted by a plurality of lamps placed side-by-side, for example 5 to 20 lamps, or even 8 to 15 lamps, so as to simultaneously treat a larger region. All the lamps may in this case emit flashes simultaneously.

The lamp is preferably placed transversely to the largest sides of the substrate. The lamp possesses a length of preferably at least 1 m, in particular 2 m and even 3 m so as to allow large substrates to be treated.

The capacitor is typically charged to a voltage of 500 V to 500 kV. The current density is preferably at least 4000 A/cm². The total energy density emitted by the flash lamps, divided by the area of the treated stack, is preferably comprised between 1 and 100 J/cm², in particular between 1 and 30 J/cm² or even between 5 and 20 J/cm².

Such high energy densities and powers allow the thin-layer stack to be heated very rapidly to high temperatures.

During the process according to the invention, each point of the stack is preferably raised to a temperature of at least 300° C., in particular 350° C., or even 400° C., and even 500° C. or 600° C. The maximum temperature is normally reached at the moment when the point of the stack in question passes under the radiating device, for example under the laser line or under the flash lamp. At a given instant, only those points of the surface of the stack which are located under the radiating device, under the laser line for example, and in the immediate vicinity thereof are normally at a temperature of at least 300° C. For distances to the laser line larger than 2 mm, in particular 5 mm, including downstream of the laser line, the temperature of the stack is normally at most 50° C. and even 40° C. or 30° C.

Each point of the stack is raised to the maximum temperature of the heat treatment for a duration advantageously comprised in a range extending from 0.05 to 10 milliseconds, in particular from 0.1 to 5 milliseconds, or from 0.1 to 2 milliseconds. In the case of a treatment by means of a laser line, this duration is set both by the width of the laser line and by the speed of relative movement between the substrate and the laser line. In the case of a treatment by means of a flash lamp, this duration corresponds to the duration of the flash.

The flash lamp device may be installed inside the vacuum deposition system or outside thereof in a controlled atmosphere or in ambient air.

The laser radiation is partially reflected by the stack to be treated and partially transmitted through the substrate. For reasons of safety, it is preferable to place, on the path of this reflected and/or transmitted radiation, means for stopping the radiation. It will typically be a question of metal jackets cooled by a flow of fluid, in particular water. In order to prevent the reflected radiation from damaging the laser modules, the axis of propagation of the or each laser line preferably makes a nonzero angle to the normal to the substrate, typically an angle comprised between 5 and 20°.

When the substrate moves, in particular translationally, it may be made to move using any mechanical conveying means, for example using belts, rollers or trays to provide a translational movement. The conveying means preferably comprises a rigid chassis and a plurality of rollers. The pitch of the rollers is advantageously comprised in a range extending from 50 to 300 mm. The rollers preferably comprise metal rings, typically made of steel, covered with plastic covers. The rollers are preferably mounted on low-play end bearings, with typically three rollers per end bearing. In order to ensure the plane of conveyance is perfectly planar, the position of each of the rollers is advantageously adjustable. The rollers are preferably moved using pinions or chains, preferably tangential chains, driven by at least one motor.

The speed of the relative movement between the substrate and each radiation source is advantageously at least 2 m/min or 4 m/min, in particular 5 m/min and even 6 m/min or 7 m/min, or even 8 m/min and even 9 m/min or 10 m/min. In certain embodiments, in particular when the absorption of the radiation by the stack is high or when the stack may be deposited at high deposition rates, the speed of the relative movement between the substrate and the radiation source is at least 12 m/min or 15 m/min, in particular 20 m/min and even 25 or 30 m/min. In order to ensure the treatment is as uniform as possible, the speed of the relative movement between the substrate and each radiation source varies during the treatment by at most 10 rel %, in particular 2 rel % and even 1 rel % relative to its nominal value.

Preferably, the radiation source remains stationary, and the substrate moves, so that the speed of the relative movement corresponds to the run speed of the substrate.

Another advantage of using an overcoat of indium metal or indium alloy lies in the excellent optical uniformity of the treated substrates.

Specifically, when large substrates bearing stacks of thin layers are treated as they run rapidly under a laser line, an optical defect called “raying” is frequently observed. This raying corresponds to a treatment uniformity defect. When the laser line under which the substrate bearing the layer to anneal is run is not perfectly regular, for example when its thickness or its power per unit length is not strictly the same all the way along the laser line, visible defects form taking the form of lines parallel to the run direction (longitudinal raying). Transverse raying (perpendicular to the run direction) also exists, this being due to irregularities in run speed.

As will be shown below in the examples, the raying of substrates annealed according to the invention is less pronounced than that observed with the absorbing overcoats of Ti metal or SnZn.

As indicated above, another subject of the present invention is a substrate obtainable with the process according to the invention. This substrate has, by way of last layer of the stack of thin layers, a layer of indium oxide or of a mixed oxide of indium and another metal. This layer is both very thin and has a characteristic surface relief formed from parabolic peaks (“sugarloafs”).

This surface relief is in particular very different from that of an ITO layer deposited by magnetron cathode sputtering, which generally has a variance (Rₐ) smaller than 1 nm, or even smaller than 0.5 nm, and which is devoid of such characteristic elements.

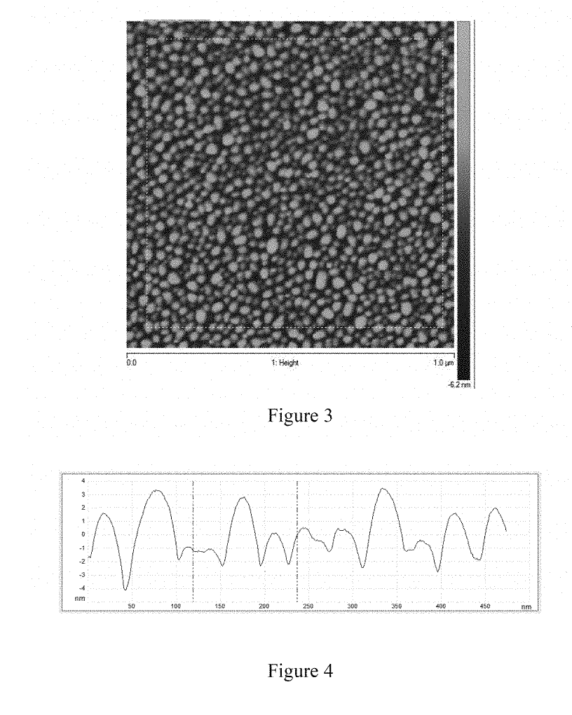

FIG. 3 shows an atomic force micrograph of the surface of an oxidized overcoat made of ITO (indium tin oxide) after heat treatment. Juxtaposed rounded grains may be seen. The roughness profile of this surface, shown in FIG. 4, shows that each of these grains corresponds to a peak having a substantially parabolic shape.

In one embodiment, the substrate obtained by the process according to the invention comprises an untempered glass sheet coated on one of its faces with a stack of thin layers comprising a thin silver layer between two thin dielectric layers, the last layer of the stack of thin layers, making contact with the atmosphere, being a layer of indium oxide or indium tin oxide (ITO) with a mass per unit area, expressed as the mass of metal atoms per unit area, comprised between 1 and 30 μg/cm² and preferably between 3 and 25 μg/cm².

The layer of indium oxide or indium tin oxide (ITO) has a surface relief with a variance (Ra) (determined by atomic force microscopy (AFM) for an area of 1 μm²) comprised between 1 and 5 nm, most of the elements of the relief having a “sugarloaf” shape.

The following examples show how effectively laser radiation is absorbed by an indium-based metal overcoat, in comparison to an overcoat of titanium metal (example 1) and to an overcoat of SnZn metal (examples 2 and 3).

### EXAMPLE 1

A thin ITO film of a thickness of about 23 nm is deposited by magnetron cathode sputtering of a ceramic target onto a 2 mm thick sheet of Planilux glass.

On two series of samples of this glass sheet, the following metal overcoats are then respectively deposited:
a 4 nm layer made of titanium (comparative example) and
a layer of (90/10) InSn (example according to the invention) having an equivalent thickness of about 5 nm.

Before heat treatment, the two series of samples have a sheet resistance (R_{□}) of about 400 ohms/□ and a light absorbance of about 20%.

The two series of samples are subjected to a laser anneal by means of a diode-pumped laser emitting laser radiation in the form of a line focused on the coating to be annealed:
wavelength of the radiation: 915+980 nm
power per unit length: 49 W/mm
width of the line in the focal plane: 45 μm
length of the line: 30 cm

The samples are run at various speeds under this laser device, then the absorbance of the visible light and the decrease in the value of P_{□} are measured in percent relative to the initial value.

The results are collated in table 1 below

TABLE 1

| | Overcoat made of | | Overcoat made of InSn | |
|---|---|---|---|---|
| | titanium | | (according to the | |
| | (comparative) | | invention) | |
| | Absorbance | Decrease | Absorbance | Decrease |
| Run speed | (%) | in R_{□} (%) | (%) | in R_{□} (%) |
| 2 m/min | — | — | 1 | 69 |
| 3 m/min | 1.5 | 62 | 1.5 | 69 |
| 4 m/min | 2 | 58 | 2 | 68 |
| 6 m/min | 4 | 52 | 5 | 65 |

It will be noted that the increases in conductivity obtained with the InSn overcoat according to the invention are larger than those obtained with the overcoat made of titanium according to the prior art. The increase in conductivity obtained for a sample according to the invention at a speed of 6 m/min is thus higher (65%) than that obtained at a speed of 3 m/min only for a sample with a titanium overcoat (62%).

These results show that an overcoat made of titanium, oxidizing into TiO₂, may advantageously be replaced by an overcoat made of InSn that gives, after oxidation, ITO.

The samples according to the invention thus have a single ITO layer and are advantageously exempt of an overcoat made of high-index TiO₂ that is liable to unfavorably modify the solar gain of a glazing.

### EXAMPLE 2

All the trials were carried out on a glazing formed by a sheet of Planiclear® glass bearing on one of its faces a low-E stack made up of the following layers in succession:

Si₃N₄ (30 nm)

TiO₂ (12 nm)

ZnO (4 nm)

Ti (0.4 nm)

Ag (13.5 nm)

ZnO (4 nm)

TiO₂ (24 nm)

Planiclear (4 mm)

Four samples that differed in the absorbing overcoat deposited by magnetron sputtering before laser treatment are prepared.

Sample 1 (comparative): 2 nm of TiO₂

Sample 2 (comparative): 3 nm SnₓZn₍₁₋ₓ₎ (x=0.35)

Sample 3 (according to the invention): 2.8 nm InSn

Sample 4 (according to the invention): 8.4 nm InSn

The four samples were subjected to a heat treatment by a laser line of a power per unit length of 25 W/mm (wavelength 915 nm and 980 nm; width of the line in the focal plane 45 μm, length of the line 30 cm). Table 2 below indicates the run speeds of the substrates, the visible absorption before and after laser treatment and the sheet resistance before and after laser treatment.

TABLE 2

| | Run | | | | | Visibility |
|---|---|---|---|---|---|---|
| | speed | Absorption (%) | | R_{□} (ohms/□) | | of the |
| Sample | (m/min) | Before | After | Before | After | raying |
| 1 (comparative) | 3 | 8.5 | 5.7 | 2.61 | 2.04 | 3.5 |
| 2 (comparative) | 5 | 23.1 | 6.1 | 2.66 | 2.03 | 2.0 |
| 3 (invention) | 5 | 19.3 | 5.4 | 2.69 | 2.19 | 1.25 |
| 4 (invention) | 15 | 32.0 | 5.8 | 2.61 | 2.05 | 1.0 |

It will be observed that the four samples have, after heat treatment, absorption and sheet resistance values that are approximately equivalent. For sample 4 bearing an 8.4 nm absorbing layer made of InSn these results have however been obtainable with a treatment speed three times higher than that used for the absorbing layer of SnZn of the prior art (sample 2).

Moreover, it may clearly be seen in the last column of the table that the “raying” of the samples treated according to the invention is significantly less visible than that of the comparative samples.

The visibility of the raying is evaluated by an operator with the naked eye according to the following marking scheme:
a grade of 1 is attributed when no nonuniformity is perceptible to the eye,
a grade of 2 is attributed when localized nonuniformities, limited to certain zones of the sample, are perceptible to the eye under bright diffuse illumination (>800 lux),
a grade of 3 is attributed when localized nonuniformities limited to certain zones of the sample are perceptible to the eye under standard illumination (<500 lux), and
a grade of 4 is attributed when nonuniformities extending over all the surface of the sample are perceptible to the eye under standard illumination (<500 lux).

### EXAMPLE 3

Two series of Planitherm type samples are prepared that differ in the absorbing overcoat used:

Series 1 (according to the invention): InSn 8.4 nm

Series 2 (comparative): SnZn 5 nm

The light absorption of the two series of samples before laser treatment is about 35%.

The samples of each series are subjected to a heat treatment, at various run speeds, under a laser line having the same characteristics as in the example 2.

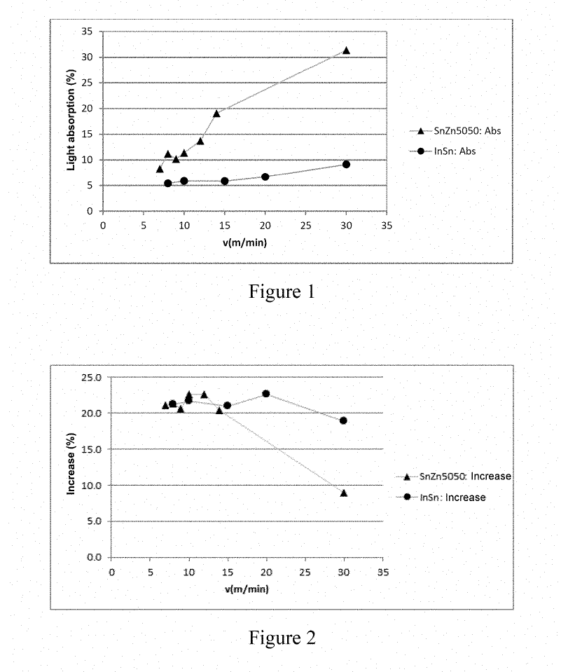

FIG. 1 shows the variation in the absorption of the visible light (in %) of the samples after laser treatment as a function of the run speed of the substrate.

It will be noted that at low run speeds (less than 10 m/minute) the light absorption of the samples of the two series is approximately equivalent (about 5-10%). As the run speed increases, the absorption difference between the two series is accentuated: the samples according to the invention preserve a relatively low absorption (lower than 10%) even at high run speeds (30 m/minute), whereas for the samples using an overcoat of SnZn, the absorption increases greatly with run speed.

FIG. 2 shows the variation in the increase in conductivity after heat treatment as a function of the run speed of the substrate. The increase in conductivity is defined as the difference between the initial R_{□} (before heat treatment) and the final R_{□} (after heat treatment) divided by the initial R_{□}.

Increase (%)=(R□initial−R□final)/R□initial

It will be noted that at low run speeds, up to about 15 meters per minute, the increase in conductivity is approximately equivalent for the two series of samples, about 20%. In contrast, at a run speed of 30 meters per minute, the increase in conductivity after heat treatment is two times greater for samples bearing an InSn overcoat according to the invention than those bearing a comparative SnZn overcoat.

1. A heat treatment process comprising irradiating a substrate comprising a transparent sheet coated on one of its faces with a stack of thin layers, under an atmosphere containing oxygen (O₂), with electromagnetic radiation having a wavelength comprised between 500 and 2000 nm, said electromagnetic radiation being emitted by an emitter device placed facing the stack of thin layers, a relative movement being created between said emitter device and said substrate, so as to raise the stack of thin layers to a temperature at least equal to 300° C. for a brief duration shorter than one second,
wherein a last layer of the stack, making contact with the atmosphere, forming an overcoat, is a metal layer of indium or of an indium-based alloy.

2. The process as claimed in claim 1, wherein a mass per unit area of the overcoat, expressed as the mass of metal atoms per unit area, is comprised between 1 and 30 μg/cm².

3. The process as claimed in claim 1, wherein the overcoat is a layer of an indium-based alloy containing more than 70% indium atoms relative to the total amount of metal atoms in the alloy.

4. The process as claimed in claim 1, wherein the overcoat is a layer of an indium-tin alloy (InSn).

5. The process as claimed in claim 1, wherein the stack of thin layers comprises at least one electrically conductive layer other than the overcoat making contact with the atmosphere, the electrically conductive layer being a metal layer or a layer of a transparent conductive oxide.

6. The process as claimed in claim 5, wherein the stack of thin layers is a low-emissivity stack comprising at least one metal layer that reflects infrared radiation between two dielectric layers.

7. The process as claimed in claim 1, wherein the penultimate layer of the stack of thin layers, which corresponds to the layer located directly under the overcoat making contact with the atmosphere, is a layer of indium tin oxide (ITO).

8. The process as claimed in claim 5, wherein the heat treatment leads to a decrease in the sheet resistance and/or the emissivity of the stack of thin layers of at least 15%.

9. The process as claimed in claim 1, wherein the electromagnetic radiation is laser radiation.

10. The process as claimed in claim 9, wherein the wavelength of the laser radiation is comprised between 900 and 1100 nm.

11. The process as claimed in claim 10, wherein the laser radiation is a laser beam focused on a plane of the overcoat in the form of a laser line simultaneously irradiating all or some of a width of the substrate.

12. The process as claimed in claim 1, wherein the device that emits the electromagnetic radiation is a flash lamp.

13. A substrate for the implementation of a process as claimed in claim 1, comprising a transparent sheet coated on one of its faces with a stack of thin layers, wherein a last layer of the stack, making contact with the atmosphere, forming an overcoat, is a layer of indium or of an indium-based alloy.

14. A substrate obtainable with a process as claimed in claim 1, comprising an untempered glass sheet coated on one of its faces with a stack of thin layers comprising a thin silver layer between two thin dielectric layers, wherein a last layer of the stack of thin layers, making contact with the atmosphere, is a layer of indium oxide or indium tin oxide (ITO) with a mass per unit area, expressed as the mass of metal atoms per unit area, comprised between 1 and 30 μg/cm².

15. The substrate as claimed in claim 14, wherein the layer of indium oxide or indium tin oxide (ITO) has a surface relief with a variance (Ra), determined by atomic force microscopy (AFM), comprised between 1 and 5 nm, most of the elements of the relief having a parabolic peak shape.

16. The process as claimed in claim 1, wherein the transparent sheet is a glass sheet.

17. The process as claimed in claim 1, wherein the brief duration is shorter than 0.1 second.

18. The process as claimed in claim 2, wherein the mass per unit area of the overcoat, expressed as the mass of metal atoms per unit area, is comprised between 3 and 25 μg/cm².

19. The process as claimed in claim 3, wherein the overcoat is a layer of an indium-based alloy containing more than 80% indium atoms relative to the total amount of metal atoms in the alloy.

20. The process as claimed in claim 4, wherein the indium-tin alloy (InSn) contains about 90% indium atoms and 10% tin atoms.

21. The process as claimed in claim 6, wherein the at least one metal layer is a silver layer.

22. The process as claimed in claim 8, wherein the heat treatment leads to a decrease in the sheet resistance and/or the emissivity of the stack of thin layers of at least 20%.

23. The process as claimed in claim 10, wherein the wavelength of the laser radiation is comprised between 950 and 1050 nm.

24. The process as claimed in claim 11, wherein the laser line simultaneously irradiates all of the width of the substrate.
